(19) United States
(12) Patent Application Publication
(10) Pub. No.: US 2006/0130036 A1
(43) Pub. Date: Jun. 15, 2006

(54) Method, system and storage medium for dynamic service activation

(75) Inventors: Susan M. Kimmel, Wappingers Falls, NY (US); William J. Schoen, Poughkeepsie, NY (US); Michael G. Spiegel, Monroe, NY (US)

Correspondence Address: CANTOR COLBURN LLP-IBM POUGHKEEPSIE, 55 GRIFFIN ROAD SOUTH, BLOOMFIELD, CT, 06002, US

(73) Assignee: International Business Machines Corporation, Armonk, NY (US)

(21) Appl. No.: 11/008,033

(22) Filed: Dec. 9, 2004

(51) Int. Cl. G06F 9/44

(52) U.S. Cl. 717/168

(57) ABSTRACT

A method for dynamic service activation, including receiving a service item, including a target component and a corresponding target service level. The target component is at a current service level. It is determined if the service item can be dynamically applied to the target component. The determining is responsive to the corresponding target service level and to the current service level. The service item is applied to the target component in response to a determination that the service item can be dynamically applied to the target component. The applying is performed in a non-disruptive dynamic manner.

### BACKGROUND OF THE INVENTION

The invention relates to dynamic service activation and, in particular to a method of dynamic non-disruptive activation of a set of service items that may include one or more service items within an operating system.

Currently, in order to activate or to remove a set of service items (e.g., an authorized program analysis report “APAR”, a user modification “usermod”, and a program temporary fix “PTF”) within an operating system component, a re-initial program load (IPL) or a shutdown and restart of the component is normally required. To get around this restriction and to allow the activation of a set of service items while the system and the particular component remain active, it is possible to utilize a shared module area or a link pack area (LPA) for components that make use of LPA parts for their modules. For a component that strictly makes use of LPA parts for its modules, dynamic LPA may be utilized to load a new version of a component load module into the system. One drawback to this solution is that it is limited to LPA parts that are reloaded or relocated every time that they are referenced and this is not a prevalent usage of LPA in an operating system. Additionally, there is no control over the interdependencies that may exist for a set of service items that span multiple load modules, thus increasing the risk that activation of the service item may introduce other errors in the system.

It would be desirable to be able to activate a set of service items in an operating system component dynamically regardless of whether the component makes use of LPA parts for its modules. Verification that the activated service is appropriate for the current component's operating system service level and the infrastructure to manage a service that is activated dynamically would also be desirable. If the activation fails, the problematic service items should be identified and the activation should not proceed.

### BRIEF SUMMARY OF THE INVENTION

Exemplary embodiments of the present invention include a method for dynamic service activation. The method includes receiving a set of service items, including a target component and a corresponding target service level. The target component is at a current service level. It is determined that the set of service items can be dynamically applied to the target component. The determining is responsive to the corresponding target service level and to the current service level. The set of service items is applied to the target component in response to a determination that the set of service items can be dynamically applied to the target component. The applying is performed in a non-disruptive dynamic manner.

Further exemplary embodiments include a storage medium for dynamic service activation. The storage medium is encoded with machine-readable computer program code for causing a computer to implement a method. The method includes receiving a set of service items, including a target component and a corresponding target service level. The target component is at a current service level. It is determined if the set of service items can be dynamically applied to the target component. The determining is responsive to the corresponding target service level and to the current service level. The set of service items is applied to the target component in response to a determination that the set of service items can be dynamically applied to the target component. The applying is performed in a non-disruptive dynamic manner.

Additional exemplary embodiments include a system for providing dynamic service activation. The system includes a service level control table corresponding to a target component. The system also includes a microprocessor in communication with the service level control table and with the target component. The microprocessor includes instructions for receiving a set of service items that contains a target component and a corresponding target service level. The target component is at a current service level. It is determined if the set of service items can be dynamically applied to the target component. The determining is responsive to the corresponding target service level, the current service level and to the service level control table. The set of service items is applied to the target component in response to a determination that the set of service items can be dynamically applied to the target component. The applying is performed in a non-disruptive dynamic manner.

### BRIEF DESCRIPTION OF THE DRAWINGS

Referring now to the drawings wherein like elements are numbered alike in the several FIGURES:

FIG. 1 depicts a block diagram of a system that may be utilized by exemplary embodiments of the present invention;

FIG. 2 depicts a process flow that may be implemented by exemplary embodiments of the present invention;

FIG. 3 depicts a block diagram of a system after a service has been activated in accordance with exemplary embodiments of the present invention;

FIG. 4 depicts a service level control information table that may be utilized by exemplary embodiments of the present invention;

FIG. 5 depicts a block diagram of a system after a second service has been activated in accordance with exemplary embodiments of the present invention;

FIG. 6 depicts a block diagram of a system after a service has been deactivated in accordance with exemplary embodiments of the present invention; and

FIG. 7 depicts a block diagram of a system after a service has been deactivated in accordance with exemplary embodiments of the present invention.

### DETAILED DESCRIPTION OF THE PREFERRED EMBODIMENTS

Exemplary embodiments of the present invention provide the capability for a broad set of operating system componentry to be able to activate service items in a non-disruptive dynamic manner. Dynamic non-disruptive activation of a set of service items refers to being able to activate the set of service items without operator involvement and without requiring a re-IPL or a shutdown and restart of the component. Validation is performed to insure that the set of service items is activated without any loss of function within a component and without any disruption to the operating system. An advantage of exemplary embodiments of the present invention is that the scope of componentry that can activate service dynamically is broadened (as compared to current capabilities which are limited to a very specific usage of LPA) while at the same time providing verification that the activated service is appropriate for the current component operating system level. In addition, exemplary embodiments of the present invention provide an infrastructure to allow a customer to manage service activated dynamically.

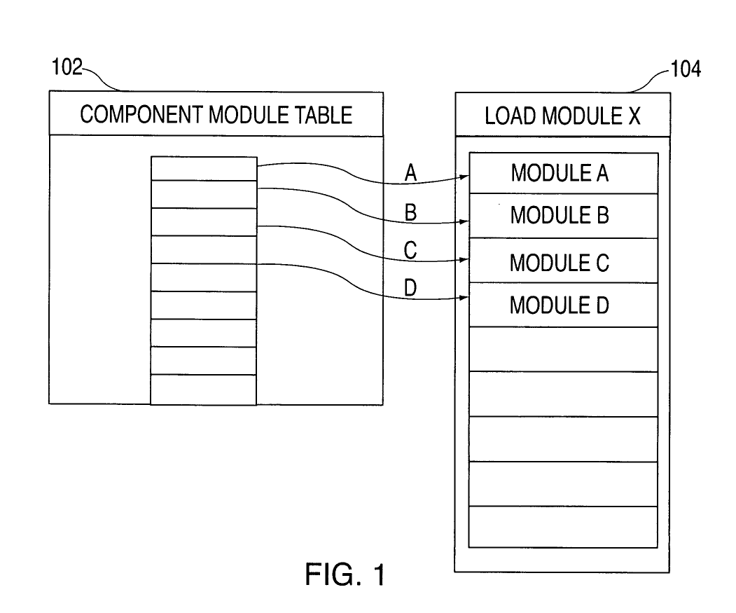

FIG. 1 depicts a block diagram of a system that may be utilized by exemplary embodiments of the present invention. Many operating system components make use of a central component module table 102 to retrieve the address of control sections (CSECTs) within a load module 104 when performing module-to-module linkages. FIG. 1 depicts the component module table 102 with pointers to CSECTs (e.g., “Module A” and “Module D”) within the load module 104 (“Load Module x”). The block diagram in FIG. 1 depicts how tables and pointers would look after an IPL has occurred. Module-to-module linkages within an operating system component are almost exclusively performed via the central component module table 102. The component module table 102 may be utilized by modules that execute continuously as part of a long running internal task by front ending the modules with stub routines that are returned periodically so that the main modules are redriven via the component module table 102.

Exemplary embodiments of the present invention support a module table structure similar to that provided by the reuse component of the z/OS operating system that is utilized by many z/OS operating system components. Examples of operating system components that utilize this module table structure include, but are not limited to, workload manager (WLM), cross system coupling facility (XCF), cross system extended services (XES), resource recovery service (RRS), advanced program to program communication (APPC), Unix system services (USS), global resource serialization (GRS), License Manager component (ILM) and Device Allocation component. Any software component that utilizes a component module table may utilize exemplary embodiments of the present invention to perform dynamic service activation. The component module table 102 contains the addresses of most, if not all, of a component's internal modules (i.e., CSECTs). When a dynamic service activation request is processed by a component, its component module table 102 is updated with the addresses of the newly loaded internal modules, or CSECTs, that are part of the activated service items. The use of the central component module table 102 also allows for the ability to store control information regarding the usage of each CSECT for use in the removal from system storage of a CSECT version when the CSECT version has been deactivated.

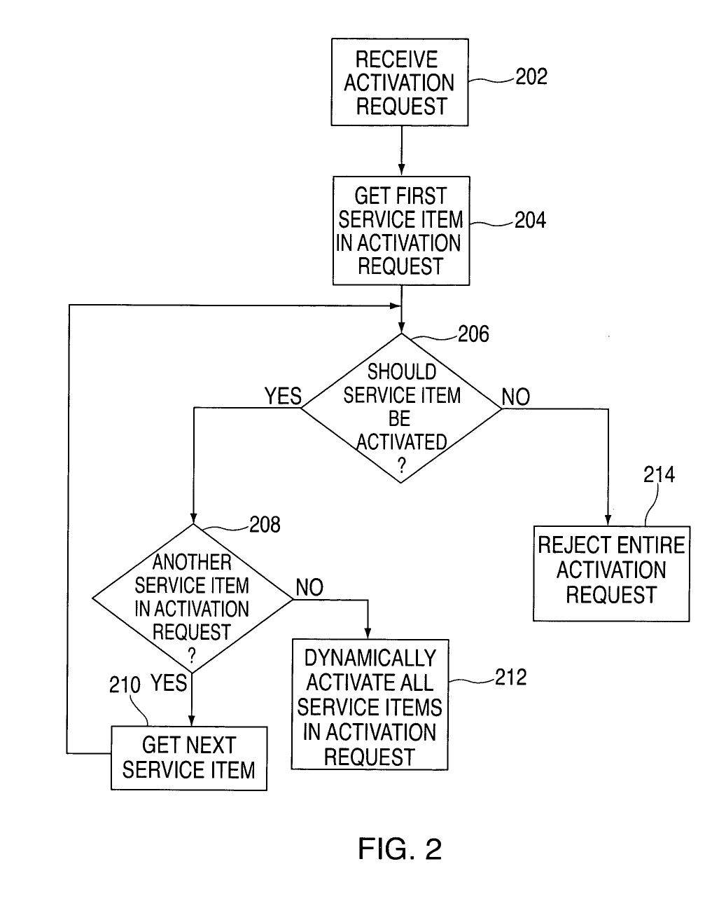

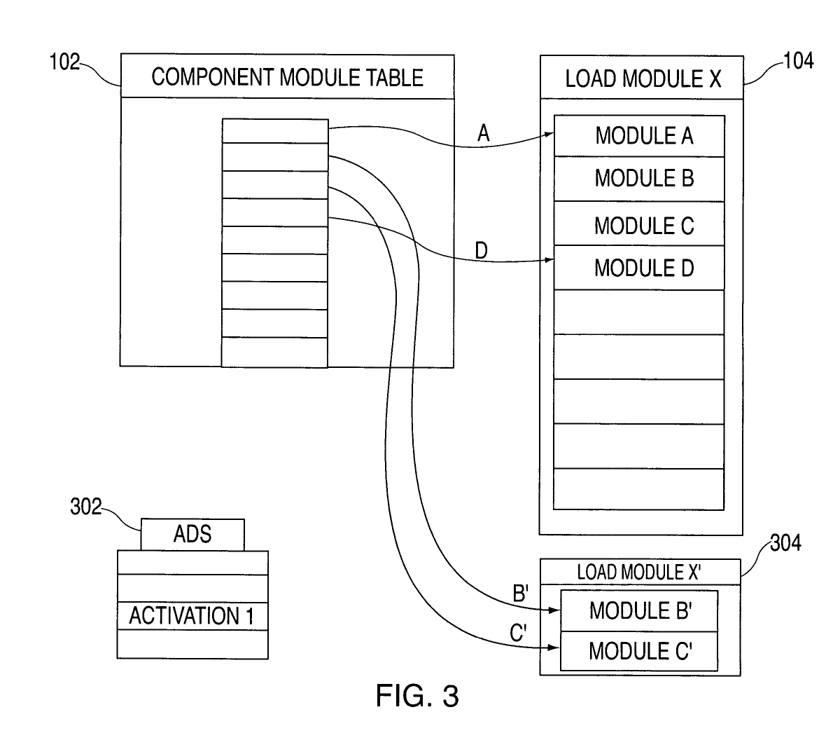

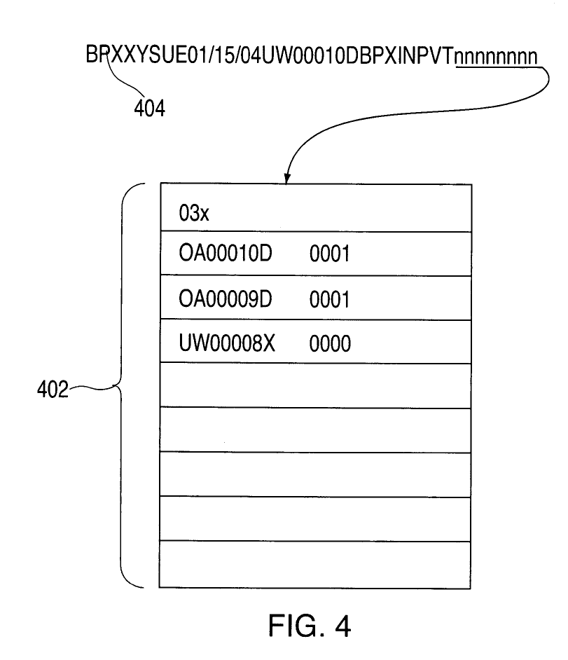

FIG. 2 depicts a process flow that may be implemented by exemplary embodiments of the present invention. At step 202, a component module receives an activation request that includes one or more service items. The request could come into the component module automatically via an operations automation script or similar method, or via a manual request from a customer operations staff member. The activation request may be targeted against the normal customer system modification program/extended (SMP/E) target install libraries and does not necessarily require any post install procedures. At step 204, the first service item contained in the activation request is accessed. At step 206, a determination is made as to whether the service item should be activated in the component. See FIG. 4 and the accompanying text for an exemplary embodiment of how the determination of whether the service item is appropriate is made. If it is determined, at step 206, that the service item should be activated, then step 210 is performed to get the next service item. If it is determined, at step 206, that a service item should not be activated, then the entire activation request is rejected at step 214. At step 210, the next service item is retrieved from the activation request and processing continues at step 206. Processing continues in this manner for each service item contained in the activation request. If all service items in the activation request can be activated, then step 212 is performed to dynamically activate each of the service items in the activation request. An exemplary embodiment of how the activation is performed is discussed below in reference to FIG. 3.

FIG. 3 depicts a block diagram of the system depicted in FIG. 1 after a set of service items has been activated in accordance with exemplary embodiments of the present invention. As a result of activating a set of service items included in “Activation 1”, pointers in the component module table 102 are pointing to one or more new target CSECTs 304 for CSECTs within the load module 104 that were modified by the activation of the service items. In exemplary embodiments of the present invention, the basic mechanism of dynamic activation is that it will load new target load modules into storage; identify which internal modules (or CSECTs) within those new target load modules contain service items to be activated; and replace the current addresses of those internal modules (CSECTs) in the component module table 102 with the addresses of the new target CSECTs 304. The next call to one of those modules, or CSECTs, within the load module 104 will result in executing the new target CSECTs 304.

The names of the target load libraries to be used on dynamic activation are identified by the installation. These target load libraries contain the customer installed service items that the customer intends to activate. An activation dynamic service (ADS) control block 302 is utilized to keep track of activations. The ADS control block 302 in FIG. 3 indicates that the customer has activated “Activation 1.” When invoking the activation routine, a component passes an ADS, including the address of the component module table 102, the component module prefix, one or more load module names and their residency, and the offset to the module information contained in module headers. In exemplary embodiments of the present invention, the activation routine performs the load of the new load modules in two phases. First, it loads into storage the load modules in the target load libraries with a new target module table that points to the CSECTs within the target load modules. The activation routine will then identify which internal modules (CSECTs) within the target load modules contain service items to be activated. Then, the activation routine will dynamically rebind the target load modules to contain only those CSECTs that are required for the activation and rebuild the target component module table 102. It is after the rebinding of the load modules that the active component module table entries 102 are replaced with the addresses of the new target CSECTs 304. Performing the rebinding results in the new target CSECTs 304 occupying a smaller amount of storage space and it avoids the storage fragmentation that may result from a load of the entire load module 104 (including the modified CSECTs) followed by freeing unused storage ranges within the load module.

Automatic verification is performed as part of the activation process to ensure that the current system level code can accept the new service without causing a problem, such as a mismatch of service or a down-leveling of service. The verification not only checks that the activated service is appropriate within a given load module, but it may also check across several load modules if the service impacts several component modules that span multiple load modules. The activation logic examines each component module impacted by the service item and it compares the target component module against the current component module to determine if the service levels are different. If the target component module has additional service, then the service level of the current component module is examined to ensure that it is at a proper service level to allow the activation of the new service. In an exemplary embodiment of the present invention, in order for the activation logic to determine what new service items are in the target load modules of a given component module, control information regarding the history of the service items of a given component module are built into each component module. The control information is utilized to compare the current system level code (i.e., the level of the current component module code) to the new service level of the code that the customer is attempting to activate (i.e., the level of the target component module code).

FIG. 4 depicts a service level control information table that may be utilized by exemplary embodiments of the present invention to determine whether a component should activate a service item. A header string 404 and a service level control information table 402 are included for each component module. In the exemplary embodiment depicted in FIG. 4, the header string 404 is made of up of thirty-two bytes of component module identity data, including component module name (“BPXXYSUE”), compile date (“01/15/2004”), the latest service level available for the component module (“UW00010D”, with the “D” designating that the latest service level can be applied dynamically), and the component load module name (“BPXINPVT”). Additional bytes are added to the end of the header string 404 (“nnnnnnnn”) to indicate the offset or address of the module's service level control information table 402.

The service level control information table 402 contains an identifier for each dynamic fix that may be applied to the component along with the number of parts in the fix. The service level control information table 402 is built and/or added to by the service team when a new service item, or fix, is developed. Also, if a dynamic service item is added to the service level control information table 402, the component module's most recent service item was not dynamic, then the most recent non-dynamic service item is added to the table with an “X” as the last character in the service item name indicating that the service item cannot be applied dynamically (e.g., “UW00008X”). The service level control information table indicates that if the current component module is at service level “U200008X”, then service items “OA00009D” and “OA00010D” may be applied dynamically. Information in the service level control information table 402 is utilized during activation verification to check that the active component module is at the correct service level to receive the new service item dynamically. If the active component module is at a level below the most recent non-dynamic service item, then the dynamic activation of any service item on this module will not be possible. The data in the service level control information table 402 will allow the verification of the parts in the service item, including the verification of whether each component module affected by the service item is at the pre-required service level (or has the ability to dynamically reach the pre-required service level) prior to the activation. If each component module affected by the service item is not at or able to be dynamically updated to the required service level, then the service item is not applied.

A successful activation will record the service item identifiers in the ADS 302, so that it is remembered which service items were part of the activation. When a successful activation replaces the addresses of modules in the component module table 102 for a set of service items, it saves the previous module addresses in the ADS 302 and does not free the storage occupied by those modules. If it is then desirable to back off the service, a deactivation request will restore the component module table 102 with the previous module addresses. Multiple activations may be performed, each one with multiple service items and each activation may be deactivated to back off that set of service. Each deactivation backs off the most recent activation. To prevent a disruption in service from occurring, deactivation will not reclaim storage. The modules will remain in storage to allow for the possibility that a unit of work that requires a prior level of service is still executing.

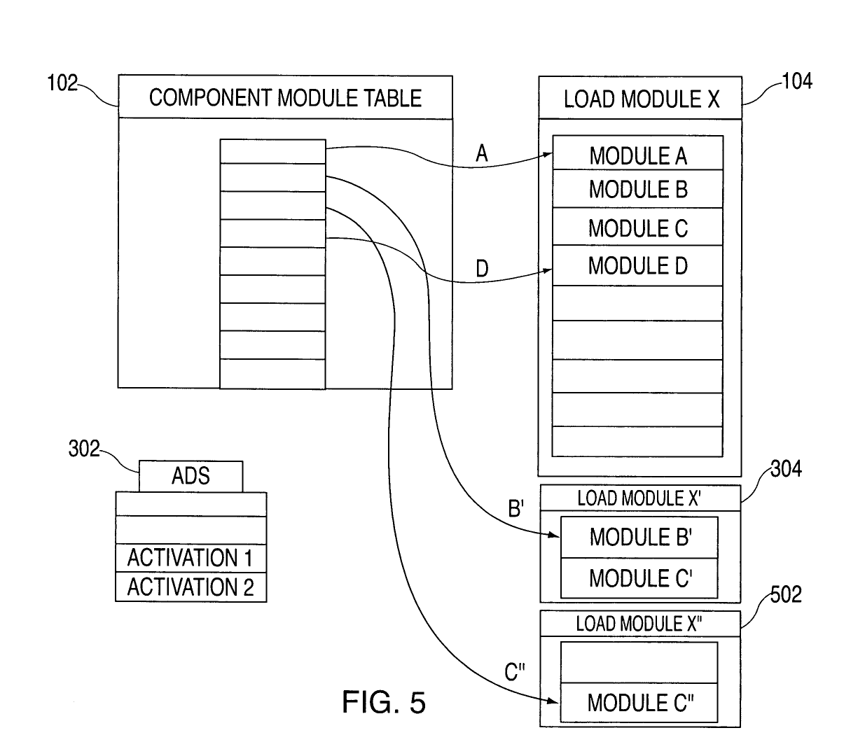

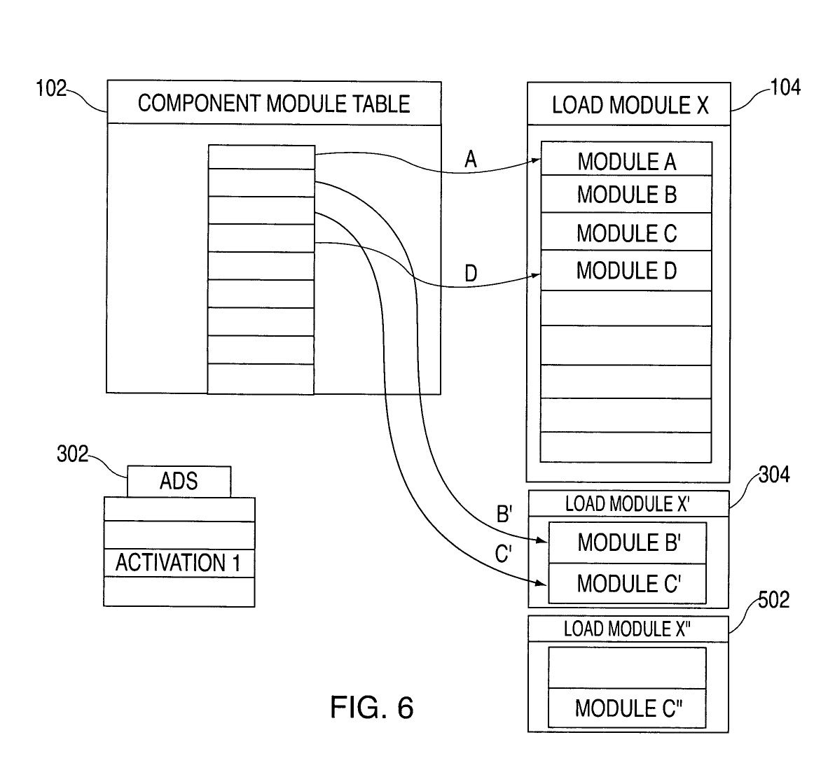

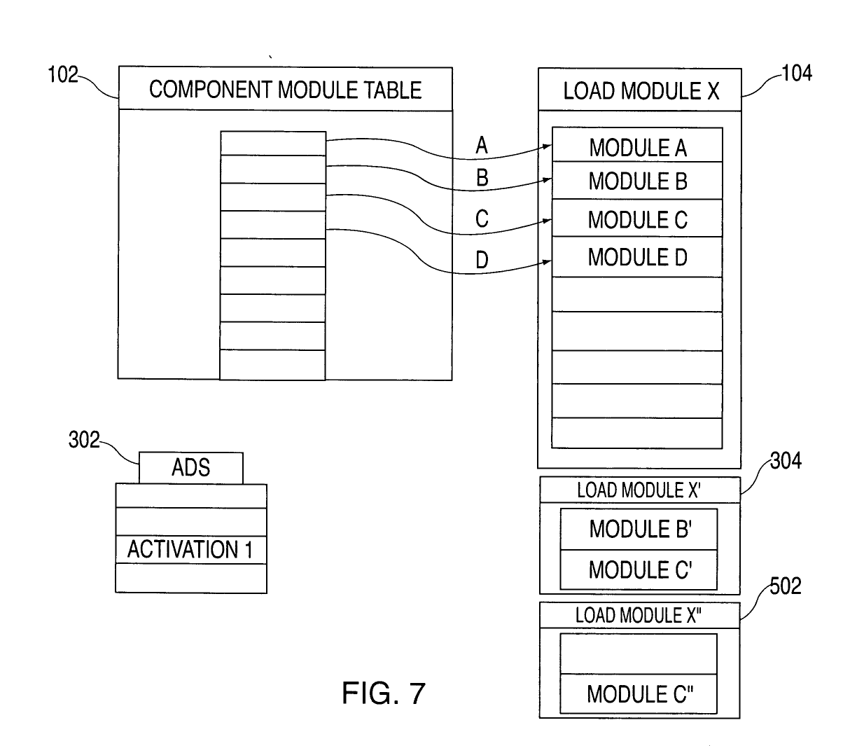

FIG. 5 depicts a block diagram of a system after a second activation (“Activation 2”) of service has occurred in accordance with exemplary embodiments of the present invention. In this example, “Activation 2” causes the Module C pointer to point to Module C.” FIG. 6 depicts a block diagram of a system after “Activation 2” has been deactivated in accordance with exemplary embodiments of the present invention. FIG. 7 depicts a block diagram of a system after “Activation 1” has been deactivated in accordance with exemplary embodiments of the present invention. An activation may include a debugging tool or diagnostic tool/mode and be deactivated after the debugging has been completed. In addition, a service item (or fix) contained in a particular activation may be found to be faulty and require deactivation to back out the fix.

In exemplary embodiments of the present invention, a query service is provided to allow a customer to display each successful activation, its set of service item identifiers and the amount of storage consumed by the activations. This activation information may be provided in a hierarchical manner so that the customer can easily determine the order that specific service items were activated on their systems.

With most components that utilize a module table like implementation, the specific recovery exit that covers an individual module is located via the central module table. This may cause errors because it is possible that with service being activated dynamically, the recovery exit could be out of sync with the mainline module entry. In order to be sure that a module's recovery exit is concurrent with the module's main line processing, the address of a module's recovery exit is recorded at the time the module is entered without depending on the module table to locate the recovery exit. In general, if any two entrypoints share the same dynamic storage area, as in this case, this type of “hardwiring” needs to be done so that the dynamic area variable mapping used is consistent across the entrypoints.

One problem with using dynamic LPA, or any other type of service that loads modules into storage, is that the entire load module must be brought in and kept in storage even though it is highly likely that only a handful of CSECTs within the load module are required for an activated service item. In an exemplary embodiment of the present invention, to use system storage in a more efficient manner, only those “selected” CSECTs that are part of the activated service items will be kept in storage; all other non-required CSECTs that are part of the loaded modules will be removed from system storage. For each load module, a directed load will be done to load the component load module into a pre-allocated component storage area and then to invoke the system binder to rebind the load module onto DASD in a temporary data set, only including those CSECTs that are relevant to the activated service items. The rebound load module will then be loaded from the temporary data set into the appropriate system storage, either common storage for LPA resident modules or the component address space's private storage for LINKLIB resident modules.

Exemplary embodiments of the present invention may be utilized to provide dynamic service activation. The ability to apply updates in a dynamic manner may allow for more fixes to be applied in a manner that is transparent to end users of the computer system. This may lead to increased customer satisfaction due to increased speed of fixing errors, better diagnostic tools and less system downtime.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for dynamic service activation, the method comprising:
receiving a set of service items including a target component and a corresponding target service level, the target component at a current service level;
determining if the set of service items can be dynamically applied to the target component, the determining responsive to the corresponding target service level and the current service level; and
applying the set of service items to the target component in response to a determination that the set of service items can be dynamically applied to the target component, wherein the applying is performed in a non-disruptive dynamic manner.

2. The method of claim 1 wherein the applying the set of service items in the non-disruptive dynamic manner includes the applying occurring without requiring a re-initial program load (IPL) of the target component.

3. The method of claim 1 wherein the applying the set of service items in the non-disruptive dynamic manner includes the applying occurring without requiring a shutdown and restart of the target component.

4. The method of claim 1 wherein the determining includes verifying that the current service level is equal to the target service level.

5. The method of claim 1 wherein the determining includes verifying that the current service level can be updated to the target service level dynamically.

6. The method of claim 1 wherein the service item includes a plurality of target component load modules and the set of service items is applied to the plurality of target component load modules in response to a determination that the set of service items can be dynamically applied to each of the plurality of target component load modules within the set of service items.

7. The method of claim 1 wherein the service item is included in an activation request.

8. The method of claim 7 wherein the activation request includes at least one other service item.

9. The method of claim 1 wherein the target component is an operating system component.

10. The method of claim 1 wherein the target component includes a component module table.

11. The method of claim 10 wherein the applying includes updating pointers in the component module table to point to control sections (CSECTS) in the target component that have been modified by the applying.

12. The method of claim 1 further comprising receiving a request to remove a previously applied set of service items and deactivating the previously applied set of service items in response to the receiving.

13. The method of claim 1 further comprising receiving a request for status information about the set of service items and transmitting the status information in response to the receiving.

14. A storage medium encoded with machine readable computer program code for dynamic service activation, the storage medium including instructions for causing a computer to implement a method comprising:
receiving a set of service items including a target component and a corresponding target service level, the target component at a current service level;
determining if the set of service items can be dynamically applied to the target component, the determining responsive to the corresponding target service level and the current service level; and
applying the set of service items to the target component in response to a determination that the set of service items can be dynamically applied to the target component, wherein the applying is performed in a non-disruptive dynamic manner.

15. The storage medium of claim 14 wherein the applying the set of service items in a non-disruptive dynamic manner includes the applying occurring without requiring a re-initial program load (IPL) of the target component and without requiring a shutdown and restart of the target component.

16. The storage medium claim 14 wherein the determining includes verifying that the current service level is equal to the target service level.

17. The storage medium of claim 14 wherein the determining includes verifying that the current service level can be updated to the target service level dynamically.

18. The storage medium of claim 14 wherein the set of service items includes a plurality of target component load modules and the set of service items is applied to the plurality of target component load modules in response to a determination that the set of service items can be dynamically applied to each of the plurality of target component load modules within the set of service items.

19. The storage medium of claim 14 wherein the target component is an operating system component.

20. The storage medium of claim 14 wherein the target component includes a component module table.

21. The storage medium of claim 20 wherein the applying includes updating pointers in the component module table to point to control sections (CSECTS) in the target component that have been modified by the applying.

22. The storage medium of claim 14, wherein the method further includes receiving a request to remove a previously applied set of service items and deactivating the previously applied set of service items in response to the receiving.

23. The storage medium of claim 14, wherein the method further includes receiving a request for status information about the set of service items and transmitting the status information in response to the receiving.

24. A system for providing dynamic service activation, the system comprising:
a service level control table corresponding to a target component; and
a microprocessor in communication with the service level control table and with the target component, the microprocessor including instructions for:
receiving a set of service items including a target component and a corresponding target service level, the target component at a current service level;
determining if the set of service items can be dynamically applied to the target component, the determining responsive to the corresponding target service level, the current service level and the service level control table; and
applying the set of service items to the target component in response to a determination that the set of service items can be dynamically applied to the target component, wherein the applying is performed in a non-disruptive dynamic manner.
